(19) United States
(12) Patent Application Publication
(10) Pub. No.: US 2018/0097450 A1
(43) Pub. Date: Apr. 5, 2018

(54) HYBRID HIGH VOLTAGE DIRECT CURRENT CONVERTER STATION AND OPERATION METHOD THEREFOR

(71) Applicant: ABB Schweiz AG, Baden (CH)

(72) Inventors: Mats Andersson, Beijing (CN); Rong Cai, Beijing (CN)

(21) Appl. No.: 15/703,509

(22) Filed: Sep. 13, 2017

Related U.S. Application Data
(63) Continuation of application No. PCT/CN2015/078855, filed on May 13, 2015.

(51) Int. Cl. H02M 7/10; H02M 7/25; H02M 7/46; H02M 7/537

(52) U.S. Cl. CPC H02M 7/10; H02M 7/537; H02M 7/46; H02M 7/25

(57) ABSTRACT

An objective of the invention to provide a hybrid converter station for HVDC system and the method operating the same. The hybrid rectifier station for high voltage direct current system includes: at least one AC bus; at least one line commutated converter configured to convert a portion of AC power supplied from the at least one AC bus to DC power transmitted on HVDC transmission line of the high voltage direct current system thereby generating reactive power demand; and at least one voltage source converter; wherein: the at least one line commutated converter and the at least one voltage source converter are coupled in parallel to the HVDC transmission line; and the at least one voltage source converter is configured to compensate the reactive power demand via the parallel coupling while converting another portion of the AC power supplied from the at least one AC bus to DC power transmitted on the HVDC transmission line. By reusing the VSC supplying both of the active power for power transmission and reactive power for LCC reactive power compensation, it is helpful for raising the total active AC power rating of the HVDC transmission system without incorporating extra power conversion device or changing the design of LCC. Besides, the nominal DC voltage of LCC and VSC is the same and the power flow shifting process is not needed.

### TECHNICAL FIELD

The invention relates to high voltage direct current (HVDC) converter station, and more particularly to hybrid converter station for high voltage direct current system and the operation method therefor.

### BACKGROUND ART

Converter stations for high voltage direct current transmission are previously well-known. Recently, a solution of dual HVDC system has been presented, for example from Florian Fein and Bernd Orlik: “Dual HVDC System with line- and self-commutated Converters for Grid Connection of Offshore Wind Farms”, which is published in International Conference on Renewable Energy Research and Applications (ICRERA), 20-23 October, 2013, Madrid, Spain (hereinafter referred to as “Florian Fein”). The Dual HVDC system consists of one line-commutated converter (LCC) and one auxiliary self-commutated voltage source converter (VSC) at both ends of a point-to-point HVDC transmission line. The dual HVDC system converter station consisting of LCC connected in parallel with VSC is one of the attractive solutions for large scale wind power transmission because of the flexibility of VSC and bulk power transmission capability of LCC.

As disclosed by Florian Fein, the transmitted DC power level fully depends on the capacity of LCC. Therefore, for an increase of the current rating for LCC, its thyristor voltage level is to be de-rated, which in turn leads to higher cost and losses.

Also, the temporary parallel operation of LCC and VSC is needed to shift the power flow between LCC and VSC according to Florian Fein. This special power flow shifting process brings the disadvantage as: assuming that DC breakers are used instead of DC disconnectors, there is still considerable dead time during which the VSC cannot be used as a STATCOM; during this time, the reactive power balance cannot be controlled. Specially in the system where the rectifier AC system is typically weak or even islanded, this brings about the system instability and mechanical wear of the DC breakers at each shifting operation.

Further, The VSC DC voltage level is much lower than the LCC in the Dual HVDC system. However the VSC active power capacity must be much larger than the minimum power level of the LCC converter (typically 0.1 p.u) in order to not shift operation mode frequently. This in turn means that the current rating of the VSC must be high. Hence the DC system losses will be relatively high in VSC operation mode since they increase with the square of the current.

### BRIEF SUMMARY OF THE INVENTION

According to one aspect of present invention, it provides a hybrid rectifier station for high voltage direct current system including: at least one AC bus; at least one line commutated converter configured to convert a portion of AC power supplied from the at least one AC bus to DC power transmitted on HVDC transmission line of the high voltage direct current system thereby generating reactive power demand; and at least one voltage source converter; wherein: the at least one line commutated converter and the at least one voltage source converter are coupled in parallel to the HVDC transmission line; and the at least one voltage source converter is configured to compensate the reactive power demand via the parallel coupling while converting another portion of the AC power supplied from the at least one AC bus to DC power transmitted on the HVDC transmission line.

According to another aspect of present invention, it provides a method for transmitting electric power via high voltage direct current system, wherein: a hybrid rectifier station of the high voltage direct current system includes at least one AC bus, and at least one line commutated converter and at least one voltage source converter being coupled in parallel to the at least one AC bus, the method includes: supplying AC power via the at least one AC bus; converting a portion of AC power supplied from the at least one AC bus to DC power by the at least one line commutated converter thereby generating reactive power demand; transmitting the DC power converted by the at least one line commutated converter via HVDC transmission line of the high voltage direct current system; compensating the reactive power demand via the at least one AC bus while converting another portion of the AC power supplied from the at least one AC bus to DC power by the at least one voltage source converter; and transmitting the DC power converted by the at least one voltage source converter via the HVDC transmission line.

According to another aspect of present invention, it provides a hybrid inverter station for high voltage direct current system including: at least one AC bus; at least one line commutated converter configured to convert a portion of DC power supplied from HVDC transmission line of the high voltage direct current system to AC power transmitted on the at least one AC bus thereby generating reactive power demand; and at least one voltage source converter; wherein: the at least one line commutated converter and the at least one voltage source converter are coupled in parallel to the HVDC transmission line; and the at least one voltage source converter is configured to compensate the reactive power demand via the parallel coupling while converting another portion of the DC power supplied from the HVDC transmission line to DC power transmitted on the at least one AC bus.

According to another aspect of present invention, it provides a method for transmitting electric power via high voltage direct current system, wherein: a hybrid inverter station of the high voltage direct current system includes at least one AC bus, and at least one line commutated converter and at least one voltage source converter being coupled in parallel to the at least one AC bus, the method includes: converting a portion of DC power supplied from HVDC transmission line of the high voltage current system to AC power by the at least one line commutated converter thereby generating reactive power demand; transmitting the AC power converted by the at least one line commutated converter via the at least one AC bus; compensating the reactive power demand via the at least one AC bus while converting another portion of the DC power supplied from the HVDC transmission line to AC power by the at least one voltage source converter; and transmitting the AC power converted by the at least one voltage source converter via the at least one AC bus.

By reusing the VSC supplying both of the active power for power transmission and reactive power for LCC reactive power compensation, it is helpful for raising the total active AC power rating of the HVDC transmission system without incorporating extra power conversion device or changing the design of LCC. This renders the system more compact and cost effective as compared with the solution proposed by Florian Fein. Besides, the nominal DC voltage of LCC and VSC is the same and the power flow shifting process mentioned in “Florian Fein” is not needed.

### BRIEF DESCRIPTION OF THE DRAWINGS

The subject matter of the invention will be explained in more detail in the following text with reference to preferred exemplary embodiments which are illustrated in the drawings, in which:

FIG. 1 illustrates high voltage direct current (HVDC) transmission system according to an embodiment of present invention;

FIG. 2 is a schematic view of exemplary LCC portion and VSC portion that may be used for the LCC 108 and the VSC 120 in the hybrid rectifier station 106 according to an embodiment of present invention; and

FIG. 3 illustrates a hybrid rectifier station of a bipolar HVDC transmission system according to an embodiment of present invention.

The reference symbols used in the drawings, and their meanings, are listed in summary form in the list of reference symbols. In principle, identical parts are provided with the same reference symbols in the figures.

### PREFERRED EMBODIMENTS OF THE INVENTION

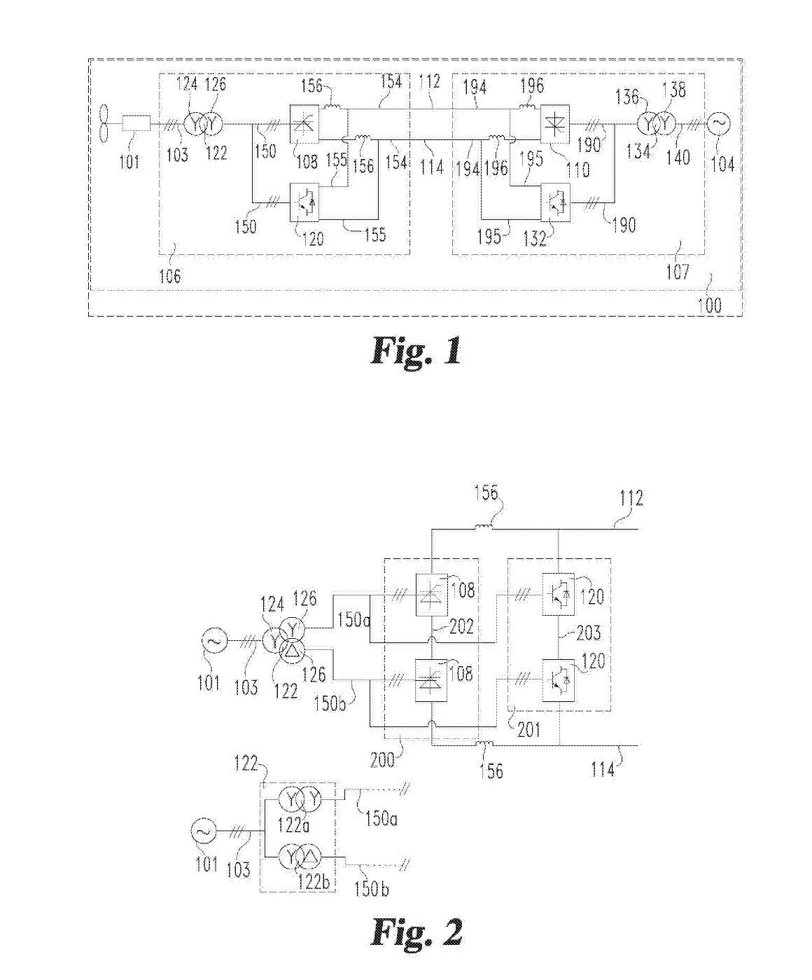

FIG. 1 illustrates high voltage direct current (HVDC) transmission system according to an embodiment of present invention. As shown in FIG. 1, HVDC transmission system 100 couples an alternating current (AC) electric power generation facility 101 to a grid 103. Electric power generation facility 101 may include one power generation device, for example, one wind turbine generator. Alternatively, electric power generation facility 101 may include a plurality of wind turbine generators that may be at least partially grouped geographically and/or electrically to define a renewable energy generation facility, i.e., a wind turbine farm. Such a wind turbine farm may be defined by a number of wind turbine generators in a particular geographic area, or alternatively, defined by the electrical connectivity of each wind turbine generator to a common substation. Also, such a wind farm may be physically positioned in a remote geographical region or in an area where physical access is difficult. For example, and without limitation, such a wind farm may be geographically located in rugged and/or remote terrain, e.g., mountainous hillsides, extended distances from the customers, and off-shore, e.g., offshore wind farm. Further, alternatively, electric power generation facility 101 may include any type of electric generation system including, for example, solar power generation systems, fuel cells, thermal power generators, geothermal generators, hydropower generators, diesel generators, gasoline generators, and/or any other device that generates power from renewable and/or non-renewable energy sources. Power generation devices 101 are coupled at an AC bus 103 of a hybrid rectifier station 106, and the distribution grid 104 is coupled to an AC bus 140 of a hybrid inverter station 107, which will be described hereinafter.

The HVDC transmission system 100 includes a hybrid rectifier station 106. The hybrid rectifier station 106 includes rectifier 108, 120 that is electrically coupled to the power generation device 101. Rectifier 108, 120 receives three-phase, sinusoidal, alternating current (AC) power from electric power generation facility 101 and rectifies the three-phase, sinusoidal, AC power to direct current (DC) power at a predetermined voltage.

In the exemplary embodiment, the rectifiers 108, 120 respectively are a line commutated converter (LCC) 108 and a voltage source converter (VSC) 120. The LCC 108 and the VSC 120 are coupled in parallel to secondary windings 126 of a transformer 122 through AC conductor 150, and a set of primary windings 124 of the transformer 122 is coupled to the power generation device 101 via an AC bus 103. The LCC 108 and the VSC 120 are coupled in parallel to HVDC transmission line 112, 114 through HVDC conductor 154, inductive device 156 and HVDC conductor 155. Therefore, the LCC 108 is configured to convert a portion of AC power supplied from the AC bus 103 to DC power transmitted on HVDC transmission line 112, 114 of the high voltage direct current system 100, and the LCC 108 and the VSC 120 are coupled in parallel to the HVDC transmission line 112, 114. For example the LCC 108 can convert and transmit active AC power within a range between approximately 80% and approximately 90% of a total active AC power rating of HVDC transmission system 100. When line commutated converters are in operation, it will require between 40% and 60% of its power rating as reactive power. LCC 108 thus generates reactive power demand.

The transformer 122 is configured to either step up or down the voltage level on AC conductor 150 based on the voltage level of AC bus 103. Transformer 122 includes one set of primary windings 124 and one set of secondary windings 126. The primary windings 124 of the transformer 122 are coupled to the AC bus 103 of the hybrid rectifier station 106, and the secondary windings 126 are coupled to the line commutated converter 108 and the voltage source converter 120. As an alternative, the transformer 122 includes one set of primary windings 124 and two substantially similar sets of secondary windings 126. The primary windings 124 of the transformer 122 are coupled to the AC bus 103 of the hybrid rectifier station 106, and the two sets of the secondary windings 126 are respectively coupled to the line commutated converter 108 and the voltage source converter 120. The active power transmitted by the LCC 108 is defined at a predetermined percentage of the total active AC power rating of the HVDC transmission system 100, for example 80%, which further defines the firing angle as well as the direct current. Accordingly, the reactive power demand by the LCC 108 is defined based on the firing angle and the direct current of the LCC 108. The reactive power supplied by the VSC 120 can be calculated to compensate the reactive power demand by the LCC 108. By using independent active and reactive power control capability of VSC 120, the active power transmitted by VSC 120 can be determined independent of the reactive power so as to transmit active power in addition to the active power transmitted by the LCC 108. For example, the VSC 120 is configured to transmit the active power within a range between approximately 10% and approximately 20% of the total active AC power rating of the HVDC transmission system 100, which is complementary or at least partially complementary to the range as transmitted by LCC 108. When the VSC 120 operates with reference to the settings of the reactive power, it can supply the reactive power to the LCC 108 via AC conductor 150. The reactive power and harmonic current flow through the converter transformer 122 is reduced hence the apparent power rating of the converter transformer 122 could be reduced. When the VSC 120 concurrently operates with reference to the settings of the active power, it can supply the active power to the HVDC transmission line 112, 114 via HVDC conductor 155. The total active AC power rating of the HVDC transmission system 100 can be increased due to the contribution of the active power transmission by both of the LCC 108 and the VSC 120. Therefore, the VSC 120 is configured to compensate the reactive power demand by the LCC 108 via the parallel coupling while converting another portion of the AC power supplied from the AC bus 103 to DC power transmitted on the HVDC transmission line 112, 114. The HVDC transmission lines 112 and 114 include any number and configuration of conductors, e.g., without limitation, cables, ductwork, and busses that are manufactured of any materials that enable operation of HVDC transmission system 100 as described herein. In at least some embodiments, portions of HVDC transmission lines 112 and 114 are at least partially submerged. Alternatively, portions of HVDC transmission lines 112 and 114 extend through geographically rugged and/or remote terrain, for example, mountainous hillsides. Further, alternatively, portions of HVDC transmission lines 112 and 114 extend through distances that may include hundreds to thousands of kilometres.

By reusing the VSC supplying both of the active power for power transmission and reactive power for LCC reactive power compensation, it is helpful for raising the total active AC power rating of the HVDC transmission system without incorporating extra power conversion device or changing the design of LCC. This renders the system more compact and cost effective as compared with the solution proposed by Florian Fein. Besides, the nominal DC voltage of LCC and VSC is the same and the power flow shifting process mentioned in “Florian Fein” is not needed.

In the preferred embodiment, for example, the active power transmitted by the LCC 108 plus that transmitted by the VSC 120 can make the total active power transmitted by the HVDC transmission system 100. Thus, the whole HVDC transmission system can have the advantage as explained above.

In the exemplary embodiment, a 6-pulse LCC 108 and corresponding 6-pulse VSC 120 are connected to the same converter transformer 122. The nominal DC voltage of LCC 108 and VSC 120 is the same. However, their DC current is different according to optimal capacity design for specific application. Thus, the LCC 108 is configured to convert the portion of the AC power by regulating its current so as to transmit a first amount of active power thereby generate a second amount of the reactive power demand. The main function of LCC 108 is to transmit the dominant portion of active power, and the function of VSC 120 includes: transmitting active power, regulating the AC bus 103 voltage of the hybrid rectifier station 106, partial DC voltage harmonic filtering and partial AC current harmonic filtering. Thus, the VSC 120 is configured to compensate the second amount of reactive power demand so as to regulate the AC bus voltage. To operate this hybrid converter station, the wind power transmitted by LCC is first defined. According to reactive power required by LCC and provided by the AC filter banks, the reactive power command for VSC is defined. Then the active power transmitted by VSC is also defined according to the apparent power of VSC. An optimization on the sharing of transmitted active power could be done by considering optimal reactive power balance.

For wind power≧0.1 p.u., both LCC 108 and the VSC 120 can transmit fluctuant wind power; for wind power<0.1 p.u., the LCC 108 will be blocked and the VSC 120 can operate to transmit wind power. No wind power will be curtailed at low wind speeds speed since there is no minimum power level of VSC and thus the operational revenues is improved. During black start phase, the VSC 120 is configured to do black start of an islanded wind power transmission system, without needing a DC polarity reversal, meaning that XLPE cables might be feasible. The HVDC transmission system 100 also includes a hybrid inverter station 107. The hybrid inverter station 107 includes inverter 110, 132 that is electrically coupled to grid 104. The inverter 110 receives DC power transmitted from rectifier 108, 120 and converts the DC power to three-phase, sinusoidal, AC power with pre-determined voltages, currents, and frequencies. In the exemplary embodiment, and as discussed further below, rectifier 108, 120 and inverter 110, 132 are substantially similar, and depending on the mode of control, they are operationally interchangeable.

Similarly, in the exemplary embodiment, hybrid inverter station 107 also includes a line commutated converter (LCC) 110 and a voltage source converter (VSC) 132 which are coupled in parallel to the HVDC transmission line 112, 114 through HVDC conductor 194, inductive device 196 and HVDC conductor 195. The LCC 110 and the VSC 132 are coupled in parallel to primary windings 136 of a transformer 134 through AC conductor 190, and a set of secondary windings 138 of the transformer 134 is coupled to the grid 104 via an AC bus 140. Therefore, the LCC 110 is configured to convert a portion of DC power supplied from HVDC transmission line 112, 114 of the high voltage direct current system 100 to AC power transmitted on the AC bus 140, and the LCC 110 and the VSC 132 are coupled in parallel to the HVDC transmission line 112, 114. Similarly, the LCC 110 will generate reactive power demand. The transformer 134 is configured to either step up or down the voltage on AC conductor 190 based on the voltage level of AC bus 104. Transformer 134 includes one set of primary windings 136 and one set of secondary windings 138. The primary windings 136 of the transformer 134 are in parallel coupled to the LCC 110 and the VSC 132 via an AC conductor 190, and the secondary windings 138 are coupled to the grid 104 via the AC bus 140. As an alternative, the transformer 134 includes one set of primary windings 136 and two substantially similar sets of secondary windings 138.

Similarly, to operate the hybrid inverter station 107, the active power transmitted by LCC 110 is first defined. According to reactive power required by LCC 110 and provided by the AC filter banks, the reactive power command for VSC 132 is defined. Then the active power transmitted by VSC 132 is also defined according to the apparent power of VSC. An optimization on the sharing of transmitted active power could be done by considering optimal reactive power balance.

By reusing the VSC supplying both of the active power for power transmission and reactive power for LCC reactive power compensation, it is helpful for raising the total active AC power rating of the HVDC transmission system without incorporating extra power conversion device or changing the design of LCC. This renders the system more compact and cost effective as compared with Florian Fein. Besides, the nominal DC voltage of LCC and VSC is the same and the power flow shifting process mentioned in “Florian Fein” is not needed.

In the preferred embodiment, for example, the active power transmitted by the LCC 108 plus that transmitted by the VSC 120 can make the total active power transmitted by the HVDC transmission system 100. Thus, the whole HVDC transmission system can have the advantage as explained above.

Similarly, the LCC 110 is configured to convert the portion of the DC power by regulating its current so as to transmit a first amount of active power thereby generate a second amount of the reactive power demand. The main function of LCC 110 is to transmit the dominant portion of active power, and the function of VSC 132 includes: transmitting active power, regulating the AC bus 140 voltage of the hybrid inverter station 107, partial DC voltage harmonic filtering and partial AC current harmonic filtering. Thus, the VSC 132 is configured to compensate the second amount of reactive power demand so as to regulate the AC bus voltage. To operate this hybrid inverter station, the wind power transmitted by LCC is first defined. According to reactive power required by LCC and provided by the AC filter banks, the reactive power command for VSC is defined. Then the active power transmitted by VSC is also defined according to the apparent power of VSC. An optimization on the sharing of transmitted active power could be done by considering optimal reactive power balance.

In the exemplary embodiment, transformers 122 and 134 have a wye-delta configuration, wye-wye configuration, or wye-wye-delta configuration. The transformer 134 is substantially similar to the transformer 122. Alternatively, the transformer 122 and the transformer 134 are any type of transformers with any configuration that enable operation of HVDC transmission system 100 as described herein.

FIG. 2 is a schematic view of exemplary LCC portion and VSC portion that may be used for the LCC 108 and the VSC 120 in the hybrid rectifier station 106 according to an embodiment of present invention. The LCC portion 200 includes a plurality of cascaded LCCs 108, and the VSC portion 201 includes a plurality of cascaded VSCs 120. The plurality of LCCs 108 are couple in series with each other through a DC conductor 202, and are coupled in parallel to the secondary windings 126 of the transformer 122 via the AC conductors 150a and 150b. The plurality of VSCs 120 are coupled in series with each other through a DC conductor 203, and are coupled in parallel to the secondary windings 126 of the transformer 122 via the AC conductors 150a and 150b. As an alternative, the transformer 122 may have two transformer units 122a, 122b. The primary windings of the transformer units 122a, 122b are coupled in parallel via the AC bus 103 to the power generation device 101, and the transformer unit 122a has wye-wye configuration and the transformer unit 122b has wye-delta configuration. This configuration could reduce the cost of converter transformer.

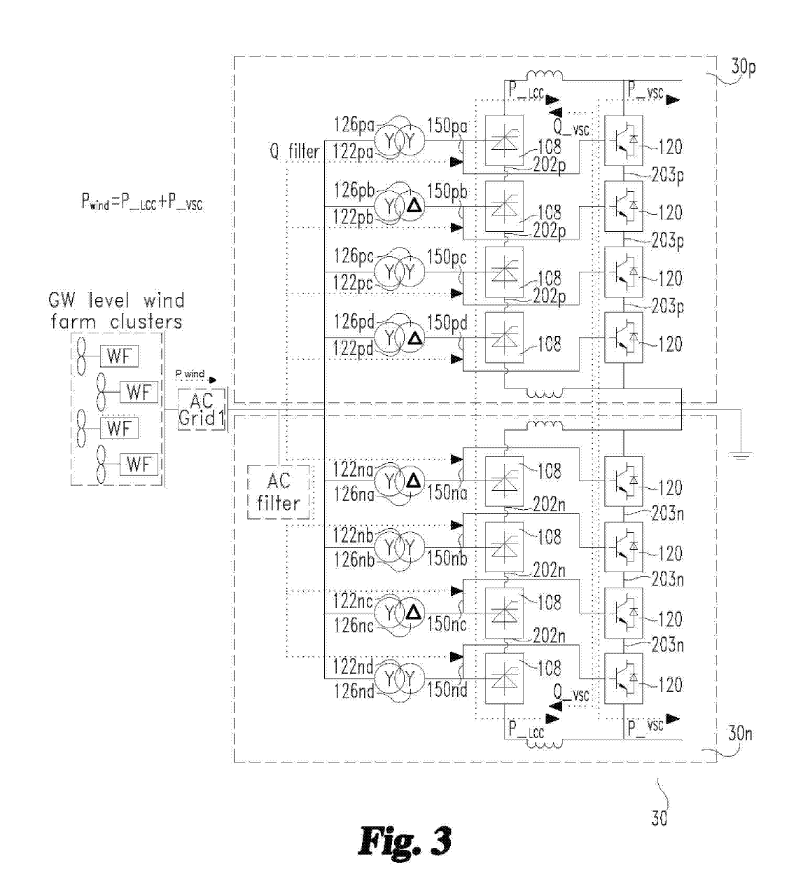

The skilled person in the art should understand that in order to transmit large scale power, the cascaded LCCs can be extended to more than two units, and the cascaded VSCs can be extended to more than two units as well. FIG. 3 illustrates a hybrid rectifier station of a bipolar HVDC transmission system. As shown in FIG. 3, the hybrid rectifier station 30 has a positive-pole rectifier 30p and a negative-pole rectifier 30n. Each of the positive-pole rectifier 30p and negative-pole rectifier 30n of the hybrid rectifier station 30 has four cascaded LCCs 108 and four cascaded VSCs 120. In the positive-pole rectifier 30p, the four LCCs 108 are coupled in series with each other through a DC conductor 202p, and are coupled respectively in parallel to the secondary windings 126pa, 126pb, 126pc, 126pd of the transformer 122pa, 122pb, 122pc, 122pd via the AC conductors 150pa, 150pb, 150pc, 150pd. The plurality of VSCs 120 are coupled in series with each other through a DC conductor 203p, and are coupled respectively in parallel to the secondary windings 126pa, 126pb, 126pc, 126pd of the transformer 122pa, 122pb, 122pc, 122pd via the AC conductors 150pa, 150pb, 150pc, 150pd. In the negative-pole rectifier 30n, the four LCCs 108 are coupled in series with each other through a DC conductor 202n, and are coupled in parallel to the secondary windings 126na, 126nb, 126nc, 126nd of the transformer 122na, 122nb, 122nc, 122nd via the AC conductors 150na, 150nb, 150nc, 150nd. The plurality of VSCs 120 are coupled in series with each other through a DC conductor 203n, and are coupled in parallel to the secondary windings 126na, 126nb, 126nc, 126nd of the transformer 122na, 122nb, 122nc, 122nd via the AC conductors 150na, 150nb, 150nc, 150nd. Though the present invention has been described on the basis of some preferred embodiments, those skilled in the art should appreciate that those embodiments should by no way limit the scope of the present invention. Without departing from the spirit and concept of the present invention, any variations and modifications to the embodiments should be within the apprehension of those with ordinary knowledge and skills in the art, and therefore fall in the scope of the present invention which is defined by the accompanied claims.

1. A hybrid rectifier station for high voltage direct current system, including:
at least one AC bus;
at least one line commutated converter configured to convert a portion of AC power supplied from the at least one AC bus to DC power transmitted on HVDC transmission line of the high voltage direct current system thereby generating reactive power demand; and
at least one voltage source converter;
wherein:
the at least one line commutated converter and the at least one voltage source converter are coupled in parallel to the HVDC transmission line; and
the at least one voltage source converter is configured to compensate the reactive power demand via the parallel coupling while converting another portion of the AC power supplied from the at least one AC bus to DC power transmitted on the HVDC transmission line.

2. The hybrid rectifier station according to claim 1, wherein:
the AC power supplied from the at least one AC bus consists of the portion converted by the at least one line commutated converter and the another portion converted by the at least one voltage source converter.

3. The hybrid rectifier station according to claim 1, wherein:
the at least one line commutated converter is further configured to convert the portion of the AC power by regulating its current so as to transmit a first amount of active power thereby generate a second amount of the reactive power demand;
the at least one voltage source converter is further configured to regulate the at least one AC bus voltage so as to compensate the second amount of reactive power demand.

4. The hybrid rectifier station according to claim 1, wherein:
the at least one line commutated converters are coupled in series to the HVDC transmission line; and
the at least one voltage source converters are coupled in series to the HVDC transmission line.

5. The hybrid rectifier station according to claim 1, wherein:
the at least one voltage source converter defines a black start current transmission path.

6. A method for transmitting electric power via a high voltage direct current system, wherein: a hybrid rectifier station of the high voltage direct current system includes at least one AC bus, and at least one line commutated converter and at least one voltage source converter being coupled in parallel to the at least one AC bus, the method includes:
supplying AC power via the at least one AC bus;
converting a portion of AC power supplied from the at least one AC bus to DC power by the at least one line commutated converter thereby generating reactive power demand;
transmitting the DC power converted by the at least one line commutated converter via HVDC transmission line of the high voltage direct current system;
compensating the reactive power demand via the at least one AC bus while converting another portion of the AC power supplied from the at least one AC bus to DC power by the at least one voltage source converter; and
transmitting the DC power converted by the at least one voltage source converter via the HVDC transmission line.

7. The method for transmitting electric power according to claim 6, wherein:
the AC power supplied from the at least one AC bus consists of the portion converted by the at least one line commutated converter and the another portion converted by the at least one voltage source converter

8. The method for transmitting electric power according to claim 6, wherein:
the conversion of the portion of the AC power is by means of regulating current of the at least one line commutated converter so as to transmit a first amount of active power thereby generate a second amount of the reactive power demand; and
the compensation of the second amount of reactive power demand is by means of regulating the at least one AC bus voltage.

9. A hybrid inverter station for a high voltage direct current system, including:
at least one AC bus;
at least one line commutated converter configured to convert a portion of DC power supplied from HVDC transmission line of the high voltage direct current system to AC power transmitted on the at least one AC bus thereby generating reactive power demand; and
at least one voltage source converter;
wherein:
the at least one line commutated converter and the at least one voltage source converter are coupled in parallel to the HVDC transmission line; and
the at least one voltage source converter is configured to compensate the reactive power demand via the parallel coupling while converting another portion of the DC power supplied from the HVDC transmission line to DC power transmitted on the at least one AC bus.

10. The hybrid inverter station according to claim 9, wherein:
the AC power transmitted on the at least one AC bus consists of the portion converted by the at least one line commutated converter and the another portion converted by the at least one voltage source converter.

11. The hybrid inverter station according to claim 9, wherein:
the at least one line commutated converter is further configured to convert the portion of the DC power by regulating its current so as to transmit a first amount of active power thereby generate a second amount of the reactive power demand;
the at least one voltage source converter is further configured to regulate the at least one AC bus voltage so as to compensate the second amount of reactive power demand.

12. The hybrid inverter station according to any of claim 9, wherein:
the at least one line commutated converters are coupled in series to the HVDC transmission line; and
the at least one voltage source converters are coupled in series to the HVDC transmission line.

13. A method for transmitting electric power via a high voltage direct current system, wherein: a hybrid inverter station of the high voltage direct current system includes at least one AC bus, and at least one line commutated converter and at least one voltage source converter being coupled in parallel to the at least one AC bus, the method includes:
converting a portion of DC power supplied from HVDC transmission line of the high voltage current system to AC power by the at least one line commutated converter thereby generating reactive power demand;
transmitting the AC power converted by the at least one line commutated converter via the at least one AC bus;
compensating the reactive power demand via the at least one AC bus while converting another portion of the DC power supplied from the HVDC transmission line to AC power by the at least one voltage source converter; and
transmitting the AC power converted by the at least one voltage source converter via the at least one AC bus.

14. The method for transmitting electric power according to claim 13, wherein:
the AC power transmitted on the at least one AC bus consists of the portion converted by the at least one line commutated converter and the another portion converted by the at least one voltage source converter.

15. The method for transmitting electric power according to claim 13, wherein:
the conversion of the portion of the DC power is by means of regulating current of the at least one line commutated converter so as to transmit a first amount of active power thereby generate a second amount of the reactive power demand; and
the compensation of the second amount of reactive power demand is by means of regulating the at least one AC bus voltage.

16. The hybrid rectifier station according to claim 2, wherein:
the at least one line commutated converter is further configured to convert the portion of the AC power by regulating its current so as to transmit a first amount of active power thereby generate a second amount of the reactive power demand;
the at least one voltage source converter is further configured to regulate the at least one AC bus voltage so as to compensate the second amount of reactive power demand.

17. The method for transmitting electric power according to claim 7, wherein:
the conversion of the portion of the AC power is by means of regulating current of the at least one line commutated converter so as to transmit a first amount of active power thereby generate a second amount of the reactive power demand; and
the compensation of the second amount of reactive power demand is by means of regulating the at least one AC bus voltage.

18. The hybrid inverter station according to claim 10, wherein:
the at least one line commutated converter is further configured to convert the portion of the DC power by regulating its current so as to transmit a first amount of active power thereby generate a second amount of the reactive power demand;
the at least one voltage source converter is further configured to regulate the at least one AC bus voltage so as to compensate the second amount of reactive power demand.

19. The hybrid inverter station according to any of claim 10, wherein:
the at least one line commutated converters are coupled in series to the HVDC transmission line; and
the at least one voltage source converters are coupled in series to the HVDC transmission line.

20. The method for transmitting electric power according to claim 14, wherein:
the conversion of the portion of the DC power is by means of regulating current of the at least one line commutated converter so as to transmit a first amount of active power thereby generate a second amount of the reactive power demand; and
the compensation of the second amount of reactive power demand is by means of regulating the at least one AC bus voltage.
